(19) United States
(12) Patent Application Publication
(10) Pub. No.: US 2022/0185104 A1
(43) Pub. Date: Jun. 16, 2022

(54) OVER THE WHEEL WELL LIQUID STORAGE TANK WITH ELECTRIC PUMPING SYSTEM

(71) Applicant: SUPERTANKS, LLC, Idaho Falls, ID (US)

(72) Inventors: Jonathan W. Barnes, Idaho Falls, ID (US); Klint Anderson, Rigby, ID (US); James E. Patience, Idaho Falls, ID (US); Woodruff D. Smith, Idaho Falls, ID (US); Kenneth S. Anderson, Idaho Falls, IS (US); R. Dru Laws, Rexburg, ID (US)

(21) Appl. No.: 17/685,538

(22) Filed: Mar. 3, 2022

Related U.S. Application Data
(63) Continuation-in-part of application No. 17/536,473, filed on Nov. 29, 2021.
Application No. 17/536,473 is a continuation of application No. 16/657,370, filed on Oct. 18, 2019, now Pat. No. 11,186,167.
(60) Provisional application No. 62/748,110, filed on Oct. 19, 2018.
(60) Provisional application No. 63/155,986, filed on Mar. 3, 2021.

(51) Int. Cl. B60K 15/06; B60K 15/03

(52) U.S. Cl. CPC B60K 15/06; B60K 2015/0638; B60K 15/03006

(57) ABSTRACT

An over the wheel well tank for storing liquid in a bed of a truck includes a tank body having a main tank portion shaped to fit in an area adjacent a wheel well in the bed of a truck and an over a wheel well tank portion shaped to fit in an area above a wheel well in the bed of a truck. The main tank portion is shaped to fit in an area adjacent a proximal side of the wheel well or in an area adjacent a distal side of the wheel well. The storage tank may further include a pumping system to pump liquid from within the storage tank to a location external to the storage tank.

### CROSS REFERENCE TO RELATED APPLICATION[S]

This application is a continuation-in-part of the earlier U.S. Utility patent Ser. No. 17/536,473, filed Nov. 29, 2021, which is a continuation of the earlier U.S. Utility patent Ser. No. 16/657,370, filed Oct. 18, 2019, now U.S. Pat. No. 11,186,167, which claims priority to U.S. Provisional Patent Application Ser. No. 62/748,110, filed Oct. 19, 2018, and this application claims priority to U.S. Provisional Patent Application Ser. No. 63/155,986, filed Mar. 3, 2021, the disclosures of which are hereby incorporated entirely herein by reference.

### BACKGROUND OF THE INVENTION

### Technical Field

This invention relates to a tank for storing liquid that is mounted in the bed of a truck adjacent to and over the wheel well.

### State of the Art

Truck owners often have need for portable liquid storage such as storage for extra fuel or water, and the like. Whether the owner needs extra fuel for the truck itself, water for drinking, or the like, having a way to store liquid in the bed of a truck is very convenient.

However, finding space for a liquid storage tank in the bed of a truck can often be tricky. Truck owners often use the bed of their trucks to move large items, to move their recreational vehicles, or the like. Therefore, mounting a large tank in the bed of a vehicle is often not practical.

Further, a loose tank in the bed of a truck can tip and spill or fall out of the truck bed. Therefore, having the tank mounted in the truck bed is often desirable.

There is space in a bed of a truck that is often unusable because of its strange shape. This space is located adjacent to and above the wheel wells which extend into the bed of a truck. Items placed in the bed of the truck are usually not placed in this space because of its restricted nature. Therefore, this space often goes unused and would be a desirable location to mount a liquid storage tank.

Accordingly, what is needed is an over the wheel well liquid storage tank that fits in the limited space located adjacent to and above the wheel well in the bed of a truck maximizing the amount of liquid stored and utilizing as much of the awkward space in this location as possible.

### SUMMARY OF THE INVENTION

An embodiment includes a tank for storing liquid in a bed of a truck, the storage tank comprising: a tank body comprising: a main tank section shaped to fit a location adjacent a wheel well in the bed of a truck; and an over the wheel well tank section shaped to fit a location above the wheel well in the bed of a truck, wherein the over the wheel well tank section is in fluid communication with the main tank section; and liquid is stored in the main tank section and the over the wheel well tank section; a lid rotatably coupled to the tank body; and a pumping system coupled within recesses of the tank body, wherein the pumping system comprises a pump, a hose coupled to the pump and a nozzle coupled to the hose, wherein the pump may be releasable coupled to a power source, the pumping system operable to pump liquid from within the tank body to a location external to the tank body.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of an over the wheel well liquid storage tank with a lid in a closed position according to an embodiment;

FIG. 2 is a top view of an over the wheel well liquid storage tank with a lid in a closed position according to an embodiment;

FIG. 3 is a bottom view of an over the wheel well liquid storage tank with a lid in a closed position according to an embodiment;

FIG. 4 is a perspective view of an over the wheel well liquid storage tank with a lid in an opened position according to an embodiment;

FIG. 5 is a top view of an over the wheel well liquid storage tank with a lid in an opened position according to an embodiment;

FIG. 6A is a perspective view of a potential bottom mounting bracket coupled to an over the wheel well liquid storage tank according to an embodiment;

FIG. 6B is a bottom view of a potential bottom mounting bracket coupled to an over the wheel well liquid storage tank according to an embodiment;

FIG. 7A is a perspective view of a potential side mounting bracket coupled to an over the wheel well liquid storage tank according to an embodiment; and

FIG. 7B is a bottom view of a potential side mounting bracket coupled to an over the wheel well liquid storage tank according to an embodiment.

### DETAILED DESCRIPTION OF EMBODIMENTS OF THE INVENTION

As discussed above, embodiments of the present invention relate to a liquid storage tank which is mounted adjacent to and above the wheel well in the bed of a truck with a pump and nozzle to pump liquid from the storage tank to a separate tank, or vehicle, including the truck to which the storage tank was mounted. In particular, disclosed is a tank body and mounting system that allows the user to utilize the often-unused space adjacent to and above the wheel well in the bed of a truck for liquid storage.

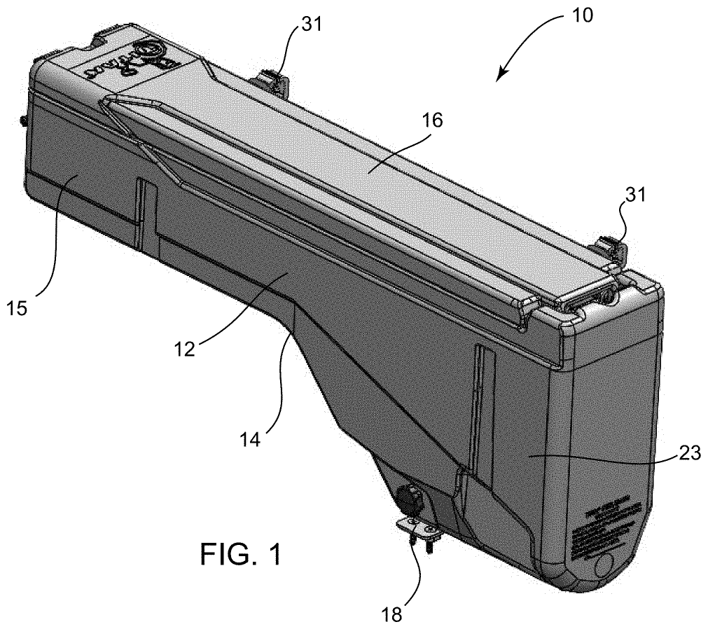

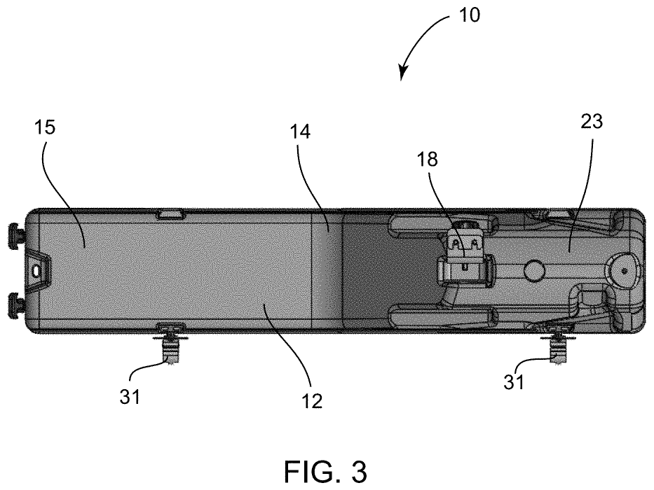

FIGS. 1-6 illustrate an over the wheel well tank 10 comprising a tank body 12. The tank body 12 is used to store the liquid. The tank body 12 may be formed from any material desirable. In particular, the tank body 12 may be formed high density cross-linked polyethylene which is strong and durable, but also light weight and inexpensive to manufacture. The tank body 12 may also be formed from other polymers, metals, composites, or combination thereof, and the like. Further, the tank body 12 may be made from a variety of polymers by way of fabrication, machining, rotational molding, blow molding, gas-assist injection molding, twin-sheet thermoforming, 3D printing, and the like. The tank body 12 may also be made from metallic materials by way of fabrication, stamping, drawing, welding, machining, and the like. Further still, the tank body 12 may also be made from fiberglass and/or composite materials using a variety of process techniques. The tank body 12 comprises two sections which are typically formed as one unit. The tank body 12 includes a main body section 23 and an over the wheel well section 15. The main body section 23 is sized and shaped to fit in an area adjacent the wheel well in the bed of the truck. In this case, adjacent means a location next to, but not necessarily touching the wheel well. The main body section 23 is sized and shaped to fit adjacent a distal side of a wheel well. The distal side of the wheel well is the area of the bed of the truck which is between the wheel well and the back of the truck bed where the tail gate would be located. The main body section 23 is also sized and shaped to fit adjacent a proximal side of the wheel well in the bed of the truck. The area adjacent the proximal side of the wheel well in the of the truck is the area between the wheel well and the cab of the truck. By shaping the main body section 23 of the over the wheel well liquid storage tank 10 to fit on either side of the wheel well, the over the wheel well liquid storage tank 10 is reversible and can be mounted with the main body section 23 of the over the wheel well liquid storage tank 10 towards the front or the back of the truck.

Tank body 12 has an approximately rectangular cross section, this cross section, however, shortens as the length of the tank body 12 is traveled. The main body section 23 of the tank body 12 has an approximately square face. The side of the main body section 23, however, that is adjacent the wheel well, may be formed at an angle in order to maximize the use of the space adjacent the wheel well and thereby maximize the amount of liquid that may be stored.

The main body section 23 of the tank body 12 may be formed in any size or shape desirable. However, in some embodiments, the main body section 23 be shaped so as to utilize as much of the area adjacent the wheel well as possible in order to maximize the amount of liquid that may be stored.

The main body section 23 of the tank body 12 is in fluid communication with the over the wheel well section 15 of the tank body 12. The over the wheel well section 15 of the tank body 12 is located over the wheel well 62 in the bed 60 of the truck. The over the wheel well section 15 is a long rectangular section with a rectangular cross section. The over the wheel well section 15 has a top and bottom that run parallel to each other. The over the wheel well section 15 is coupled to the main body section 23 at a location where the bottom of the over the wheel well section 15 and the side of the main body section 23, which is adjacent the wheel well, form an angle 14. Angle 14 may be any angle desirable. In particular, it may be an angle 14 that maximizes the amount of liquid storage. The angle 14 should also, however, be an angle that allows the over the wheel well liquid storage tank 10 to be mounted in a variety of different makes and models of truck.

The over the wheel well section 15 of the tank body 12 may be formed in any shape desired. In some embodiments, the over the wheel well section 15 of the tank body 12 will be formed to maximize the area between the top of the wheel well 62 and the top of the wall of the truck bed 66. The over the wheel well section 15 should be formed to maximize the space available while allowing the tank body 12 to fit in multiple makes and models of vehicles. Therefore, depending on the make and model off the truck, the over the wheel well section 15 may or may not abut the top of the wheel well 62. This is true also of the main body section 23 of the tank 10. The main body section 23 may or may not abut the side of the wheel well depending on the make and model of the truck the tank 12 is placed in.

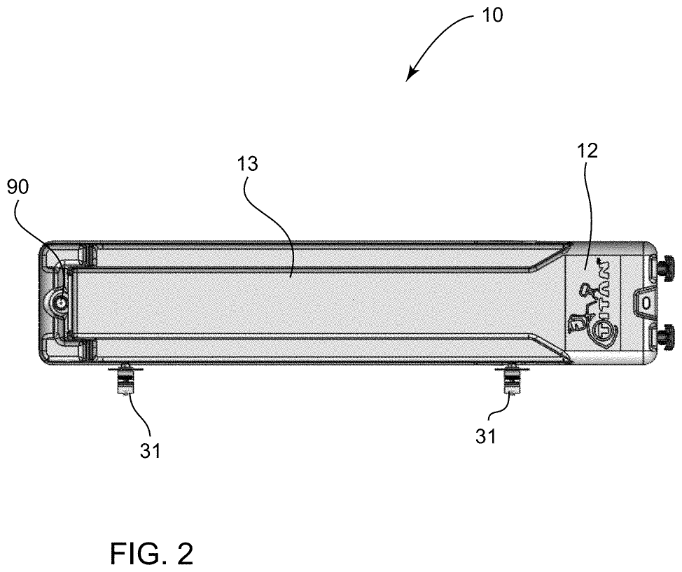

An additional opening shown in the top of the tank body 12 holds a grounding stud system. This grounding stud opening system includes a grounding stud 90 as illustrated in FIG. 2. The grounding stud 90 acts to ground any static electricity which may exist in the tank body 12. The grounding stud 90 may be a metal rod or other type of conductive rod which is inserted into the tank body 12 to attract any electric charge that might form inside. The grounding stud 90 may be inserted through a grommet and then the grommet and the grounding stud 90 are inserted into the grounding stud opening in the tank body 12. The grommet may be a rubber grommet that is designed to form a tight seal between the grounding stud 90 and the grounding stud opening in the tank body 12.

A grounding wire is coupled between the grounding stud 90 and metal on the truck. The grounding wire provides a path for any electric charge accumulated by the grounding stud 90. The electricity travels through the grounding stud 90, through the grounding wire 40 and is dissipated into the truck body. The grounding wire 40 may be any type of wire that conducts electricity.

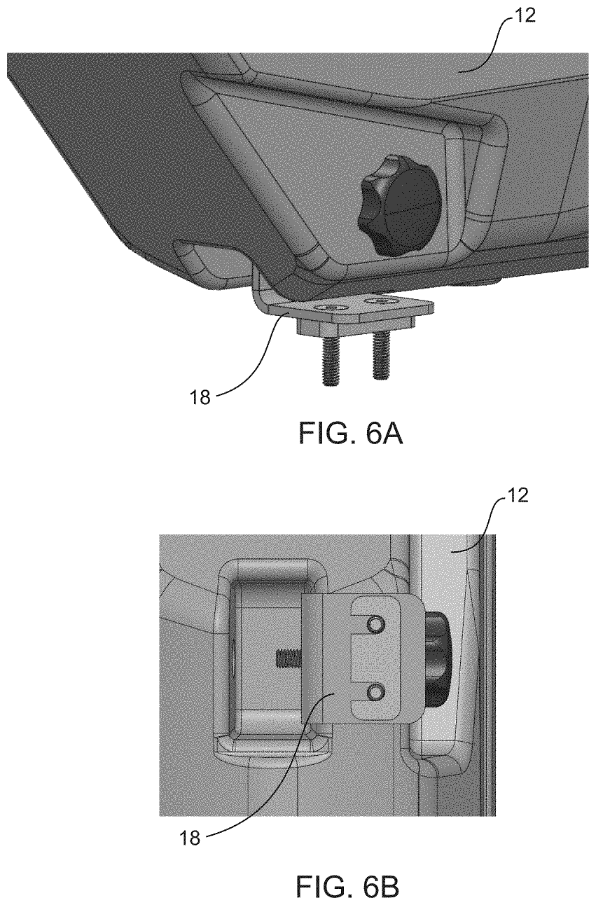

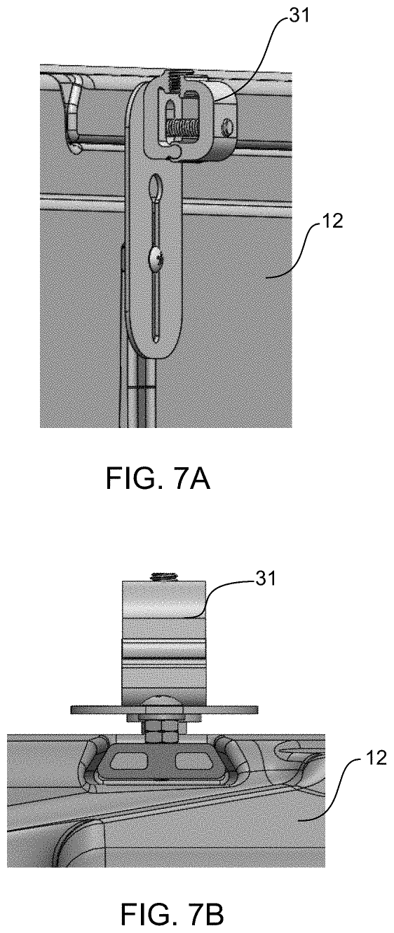

With additional reference to FIGS. 6A-7B, the bottom mounting bracket 18 and the side mounting brackets 31 may be adjustable in order to properly mount the tank body 12 within the truck bed. This can account for variations in sizes of wheel wells, distance from the side of the truck bed, and so forth.

While the brackets shown in FIGS. 6A-7B may be used to mount the tank body within the truck bed, other brackets or mounting systems are contemplated. For example, and without limitation, one system may be “semi-permanent”, meaning it would take a while and some effort to remove the tank body 12 from the truck. In this system, the storage tank 10 is intended to remain mounted to the truck bed. Another system may be modular and “temporary”, thus allowing a user to quickly coupled and decouple the tank 10 and take it in and out of the truck bed easily when needed.

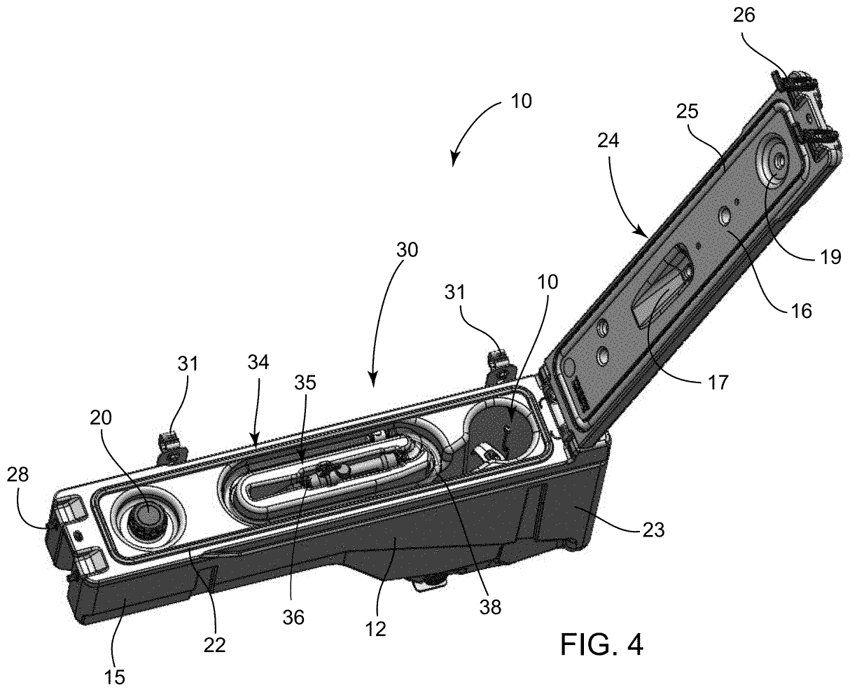

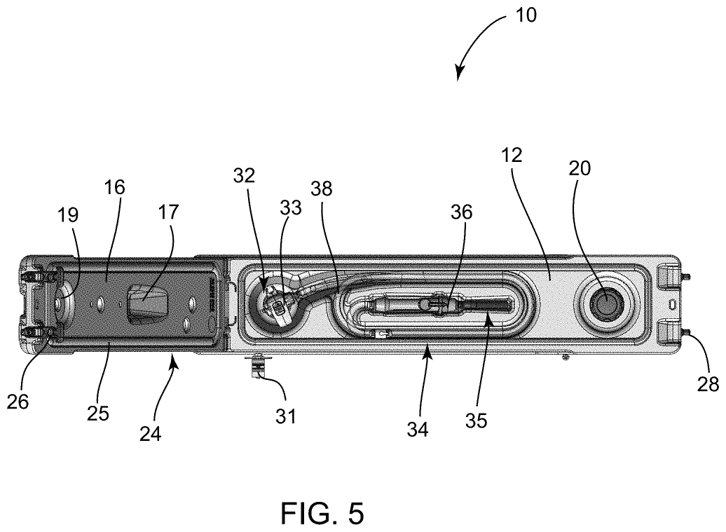

With additional reference to FIGS. 4 and 5, the storage tank 10 further comprises a lid 16 rotatably coupled to the tank body 12 of the storage tank 10. The lid 16 may be coupled to the tank body 12 by a hinge or means for rotating the lid between an opened position (see FIGS. 4 and 5) and a closed position (se FIGS. 1-3). The lid 16 in the closed position covers a pumping system 30 and a cap 20 that is removably coupled to the fill opening of the tank body 12. The tank body 12 may include a lip 22 protruding from a top surface of the tank body 12. The lid 16 includes a recess 24 corresponding to the lip 22, wherein the lip 22 is extended within the recess 24 when the lid 16 is in the closed position. The lid 16 may include a sealing member 25 that may be located within the recess 24, wherein the seal member 25 engages the lip 22 to form a seal between the tank body 12 and the lid when in the closed position. The lid 16 and the tank body 12 may include a locking mechanism to lock the lid 16 in the closed position. The lock mechanism may include a latch 26 coupled to an end of the lid 16 and protrusion 28 extending from the tank body 12 wherein the latch 26 can engage the protrusion when in the closed position.

The tank body 12, as part of the pumping system 30, may include a pump recess 31, a hose recess 34, and a nozzle recess 33 formed in the tank body 12. Further, the pumping system 30 includes a pump 32, a hose 38 and a nozzle 36. The pump 33 may be coupled within the pump recess 32, the pump 33 accessing the liquid stored within the tank body 12. The hose 38 may be coupled on one end to the pump 33 and may be wound within the hose recess 34 when storing the hose during non-use. The nozzle 36 may be coupled to an end of the hose 38 not coupled to the pump 33. The nozzle 36 may be retained within the nozzle recess 33 during non-use. During use of the pumping system 30, the nozzle 36 and the hose 38 may be removed from their respective recesses when the lid 16 is moved to the opened position. The pump 33, which may be an electric pump, may then be connected to a power source, such as the battery of the truck to which storage tank is mounted. The operation of the nozzle 36 may then be utilized to activate the pump 33 and pump liquid from within the tank body 12 and into another tank of like liquid. The lid 16 may also include recesses 17 and 19 corresponding to the cap 20 and the nozzle 36 to allow the lid 16 to close completely on the tank body 12.

It will be understood that other components of the of the storage tank 10 may include components similar to those found in U.S. Pat. No. 9,669751, the disclosure of which is incorporate entirely herein by reference.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A tank for storing liquid in a bed of a truck, the liquid storage tank comprising:
a tank body comprising a main tank section shaped to fit a location adjacent a wheel well in the bed of a truck; and
an over the wheel well tank section shaped to fit a location above the wheel well in the bed of a truck, wherein:
the over the wheel well tank section is in fluid communication with the main tank section; and
wherein liquid is stored in the main tank section and the over the wheel well tank section;
a lid rotatably coupled to the tank body; and
a pumping system coupled within recesses of the tank body, wherein the pumping system comprises a pump, a hose coupled to the pump and a nozzle coupled to the hose, wherein the pump may be releasable coupled to a power source, the pumping system operable to pump liquid from within the tank body to a location external to the tank body.

2. The liquid storage tank of claim 1, wherein the tank body further comprises a pump recess, wherein the pump is coupled within the pump recess, the pump accessing the liquid stored within the tank body.

3. The liquid storage tank of claim 2, the tank body further comprising a hose recess, wherein the hose is wound within the hose recess when storing the hose during non-use.

4. The liquid storage tank of claim 3, wherein the tank body further comprises a nozzle recess, wherein the nozzle is retained within the nozzle recess during non-use.

5. The liquid storage tank of claim 1, wherein the lid is rotatable between an opened position and a closed position, wherein the lid in the closed position covers the pumping system and a cap that is removably coupled to a fill opening of the tank body where liquid is stored.

6. The liquid storage tank of claim 5, wherein the tank body includes a lip protruding from a top surface of the tank body and the lid includes a recess corresponding to the lip, wherein the lip is extended within the recess when the lid is in the closed position.

7. The liquid storage tank of claim 6, wherein the lid includes a sealing member that is located within the recess, wherein the seal member 25 engages the lip 22 to form a seal between the tank body 12 and the lid when in the closed position.

8. The liquid storage tank of claim 7, further comprising a locking mechanism to lock the lid in the closed position.

9. The liquid storage tank of claim 8, wherein the lock mechanism includes a latch coupled to an end of the lid and protrusion extending from the tank body, wherein the latch engages the protrusion when in the closed position to lock the lid in the closed position with tank body.
